(19) United States
(12) Patent Application Publication
(10) Pub. No.: US 2015/0261864 A1
(43) Pub. Date: Sep. 17, 2015

(54) Computer Systems and Method for Obtaining Produced Content

(71) Applicant: A4 Innovation Inc., Montreal (CA)

(72) Inventor: Guillaume FREDETTE, Montreal (CA)

(21) Appl. No.: 14/577,184

(22) Filed: Dec. 19, 2014

Related U.S. Application Data
(60) Provisional application No. 61/951,144, filed on Mar. 11, 2014.

(51) Int. Cl. G06F 17/30; H04L 29/08; H04L 29/06

(52) U.S. Cl. CPC G06F 17/30864; H04L 67/42; H04L 67/10

(57) ABSTRACT

Computer systems and method for obtaining produced content. At a computer system, a request for content is received for an application executing on a remote network node via a network interface module of the computer system. In response to the request, one or more queries are performed and a dataset corresponding to the one or more queries is sent. The dataset comprises produced content ready to be distributed to the application in a single response. The computer system may comprise a database module and a server module. A client request for content may further be received from the application at the server module. The request may comprise data from the client request and may be sent from the server module to the database module. Following reception of the produced content from the database module, the server module may send the produced content towards the application in the single response.

### PRIORITY STATEMENT UNDER 35 U.S.C §119 (E) & 37 C.F.R. §0.1.78

This non-provisional patent application claims priority based upon the prior U.S. provisional patent applications entitled “COMPUTER SYSTEMS AND METHOD FOR OBTAINING PRODUCED CONTENT”, application No. 61/951,144, filed Mar. 11, 2014, in the name of A4 Innovation Inc with FREDETTE, Guillaume as a named inventor, which is hereby incorporated by reference in its entirety.

### TECHNICAL FIELD

The present invention relates to processing client request(s) into content by an application and, more particularly, to generating content by an application and its associated DBMS.

### BACKGROUND

While being functional, the underlying programming structures of content delivery through a browser is a heap of ad hoc construct added to one another in an uncoordinated manner. The invention seeks to enhance the content delivery model and therefore reduce content processing time.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A first aspect of the present invention is directed to a computer system comprising a network interface module for receiving a request for content for an application executing on a remote network node and, in response to the request, causing the computer system to perform one or more queries. The network interface module is also for sending a dataset corresponding to the one or more queries, the dataset comprising produced content ready to be distributed to the application as a single response related to the request.

Optionally, the computer system may further comprise a database module for performing the one or more queries towards one or more database tables. The database module may also be for performing the one or more queries without reference to one or more database tables. Each of the one or more queries may also comprise at least some of the raw data from the request.

Optionally, the computer system may further comprise a database module for performing the one or more queries having an internal database address on the network interface module and a server module having an external server address on the network interface module and an internal server address on the network interface module. The server module may further be for receiving a client request for content from the application executing on the remote network node on the external server address of the network interface module, sending the request for the application comprising data from the client request on the internal database address of the network interface module and, following reception of the produced content on the internal server address of the network interface module from the database module, sending the single response to the client request comprising the produced content towards the application. In this exemplary option, the application may be a consumer and the produced content may be ready to be processed as is by the consumer. The produced content may comprise HTML code, XML code, binary code and/or JSon code. The produced content may also comprise dynamic data comprising at least one of parsed raw data from the client request, dynamic data from the dataset and computed dynamic data.

Optionally, the computer system may further comprise a database module for performing the one or more queries, which comprise a function that requires at least one parameter and contains at least one query. The function may produce the produced content and the one or more queries may return the produced content as is.

Optionally, the computer system may further comprise a database module for performing the one or more queries, which are sent to a server-side procedure that converts the raw data from the client request into parameters.

Optionally, the computer system may further comprise a database module for performing the one or more queries, which are sent to a server-side procedure that proceeds to branching including a plurality of SQL objects. The plurality of SQL objects may comprise at least one of simple SQL queries, TVF, UDF, SP, arithmetic operations, simple string aggregation and execution of compiled programming. The plurality of SQL objects may also use dynamic data and/or computed data and/or static data for creating the produced content.

A second aspect of the present invention is directed to a method for obtaining produced content comprising, at a computer system, receiving a request for content via a network interface module of the computer system, wherein the request is related to an application executing on a remote network node and, in response to the request, performing one or more queries. The method also comprises, from the computer system, sending a dataset corresponding to the one or more queries, the dataset comprising produced content ready to be distributed to the application as a single response related to the request via the network interface module of the computer system.

Optionally, the one or more queries are made towards one or more database tables, the one or more queries may contain data without reference to one or more database tables and/or each query may comprise at least some of the raw data from the client request.

The computer system in accordance with the second aspect of the present invention may optionally comprise a server module having an external server address on the network interface module and an internal server address on the network interface module and a database module for performing the one or more queries having an internal database address on the network interface module. In this example, the method may further comprise receiving, on the external server address of the network interface module, a client request for content from the application executing on the remote network node, sending the request comprising data from the client request towards the internal database address of the network interface module and, following reception of the produced content on the internal server address of the network interface module from the database module, sending the single response to the client request comprising the produced content towards the application from the external server address of the network interface module. The application may be a consumer and the produced content may be ready to be processed by the consumer. The produced content may comprise HTML code, XML code, binary code and/or JSon code. The produced content may also comprise dynamic data comprising at least one of parsed raw data from the client request and dynamic data from the dataset and computed dynamic data.

Optionally, at least one of the one or more queries may comprise a function, that requires at least one parameter and contains at least one query, the function producing the produced content and the one or more queries return the produced content as is. At least one of the one or more queries may also be sent to a server-side procedure that converts the raw data from the client request into parameters and/or that proceeds to branching including a plurality of SQL objects. The plurality of SQL objects may comprise at least one of simple SQL queries, TVF, UDF, SP, arithmetic operations, simple string aggregation and execution of compiled programming and the plurality of SQL objects may use dynamic data and/or computed data and/or static data for creating the produced content.

A third aspect of the present invention is directed to a computer system comprising a network interface module for receiving a client request for content from an application executing on a remote network node and, in response to the client request, sending a server request for the content to a database management system. The network interface module is also for receiving a dataset corresponding to the requested content from the database management system, the dataset comprising produced content ready to be distributed and sending the produced content towards the application in a single response to the client request.

Optionally, sending the server request for the content to the database management system may comprise sending a single server request that comprises raw data from the client request. The dataset may be obtained at the database management system from one or more queries. The one or more queries may be made towards one or more database tables, the one or more queries may contain data without reference to one or more database tables and/or each query may comprise at least some of the raw data from the client request.

### BRIEF DESCRIPTION OF THE DRAWINGS

In the diagrams, like numerals represent like elements. Further features and exemplary advantages of the present invention will become apparent from the following detailed description, taken in conjunction with the appended drawings, in which:

FIG. 1 is a logical modular representation and flow chart of a first exemplary sub-optimal content aggregation embodiment in accordance with the teachings of the present invention;

FIG. 2 is a logical modular representation and flow chart of first exemplary embodiment of produced content distribution in accordance with the teachings of the present invention;

FIG. 3 is a logical modular representation and flow chart of a second exemplary embodiment of produced content distribution in accordance with the teachings of the present invention;

FIG. 4 is a logical modular representation and flow chart of a third exemplary embodiment of produced content distribution in accordance with the teachings of the present invention;

FIG. 5 is a logical modular representation and flow chart of a first exemplary embodiment of content production in accordance with the teachings of the present invention;

FIG. 6 is a logical modular representation and flow chart of a second exemplary embodiment of content production in accordance with the teachings of the present invention;

FIG. 7 is a logical modular representation and flow chart of a third exemplary embodiment of content production in accordance with the teachings of the present invention;

FIG. 8 is a logical modular representation and flow chart of a fourth exemplary embodiment of content production in accordance with the teachings of the present invention;

FIG. 9 is a logical modular representation and flow chart of a fifth exemplary embodiment of content production in accordance with the teachings of the present invention;

FIG. 10 is a logical modular representation a first exemplary embodiment of a computer system in accordance with the teachings of the present invention;

FIG. 11A and FIG. 11B, together referred to as FIG. 11, are logical modular representations exemplary embodiments of computer systems in accordance with the teachings of the present invention; and

FIG. 12 is a flow chart of an exemplary method for producing content in accordance with the teachings of the present invention.

### DETAILED DESCRIPTION

### Glossary

Throughout this document, various exemplary embodiments of the invention are described using acronyms and shorthand notations to aid the understanding of certain aspects of the claimed invention. These acronyms and shorthand notations are intended for the purpose of providing an easy methodology of communicating ideas expressed herein and are not meant to limit the scope of the invention, which is defined by the claims.

Application: Any software traverses information resources to a browser.

Branching: A method of constructing a computer program to execute different instruction sequence, which may or may not be conditional.

Browser: A software for retrieving, presenting and traversing information resources (content).

Client: A software receiving the traversed information resource or a person receiving the traversed information resource through the software.

CMS: A Content Management System is a computer program that allows publishing, editing and modifying content as well as maintenance from a central interface.

Constructor query: Refers to a query that is used to construct a second query from a set of parameters/variables when executed.

Consumer: Represents a person/process/software that uses data and/or content.

Cycle: A grouping of the methods encapsulate by the domain logic.

Database: An organized collection of data.

Dataset: Refers to one or more organized set of data.

DBMS: A DataBase Management System is a software designed to allow the definition, creation, querying, update and administration of databases.

Domain logic: The part of a software that determine how data can be created, displayed stored and changed.

HTML: The HyperText Markup Language and its equivalents.

JSON: The JavaScript Object Notation and its equivalent.

Produced content: Content that a client can consume (e.g., display in the browser or be used by other application(s) at the client).

Produced query: Refers to a query that was constructed by a constructor. The produced query can be run and/or saved from/to a database.

Producer: Represents a person/process that creates data and/or content.

Server: A hardware (computer) or software (application) used to deliver content that can be accessed through a network.

Sniffing: The action of sending at least one malevolent request to an application in order to cause an error with the purpose of guessing the parameters, structure and/or data type used.

SP: A Stored Procedure is a programming structure within a DBMS.

SQL: The Structure Query Language is a special-purpose programming language designed for managing data held in a DBMS.

Static data: Defines data that can only be modified/added/deleted directly into the code by a person, commonly referred to as a “programmer” and/or “developer”.

SVF: Refers to the SQL object named Scalar Valued Function.

TVF: A Table Value Function is a programming structure within a DBMS.

UDF: A User Defined Function is a programming structure within a DBMS.

XML: The eXtensible Markup Language and its equivalent.

Current programming structures of content delivery through browser are a heap of ad hoc constructs added to one another in an uncoordinated manner. The whole heap holds, but is not optimized for generating dynamic content for a client. Within those superimposed programming structures, it is possible to find means of enhancing content delivery amongst the different software components, improving security and lowering operational costs.

Under the currently accepted content delivery model, the response to a client request handled by an application often shows a heap of communication with its associated DBMS for the purpose of producing the requested content. This heap of communication is usually caused by the domain logic being located within the application itself and having to generate large and inefficient queries to the DBMS to achieve the task. This heap of communication creates a throng of tasks sent by the application to be executed by the DBMS and then assembled back by the application, one at a time, and sent in turn as combined result of these tasks towards the browser and/or the client.

The invention aims at enhancing the stream of communication between the application and the DBMS. In embodiments of the present invention, enhancements are obtained by moving the domain logic and its accompanying programming to the DBMS. The proposed architecture of these embodiments causes the DBMS to become one of the central points of a CMS if not the singular point of the CMS. The proposed architecture also allows the application to focus more of its resources into content delivery to the client. In some embodiments, the domain logic is only executed within the DBMS, requiring a single query from the application to the DBMS to retrieve the entirety of the produced content requested by the client. In other words, the domain logic is thereby located in the database instead of the application. Programming elements that participate in managing the content from the application are moved to the DBMS. Rather than programming the domain logic inside the application, the domain logic is programmed in, and thereafter executed by, the DBMS. The invention seeks to cause the delivery of produced the content to a client more efficient, more stable, more energy conscious and more economic.

The present invention has been partly developed while experimenting to improve security of applications. The experiments led to moving at least portions of the domain logic from the application directly into the DBMS. One noticed unintended effect of the move of the domain logic to the DBMS was significant gains on server efficiency, processing speed and energy consumption. The noticed unintended effect became the central topic of following research efforts, which led to the solution of the present invention. Preconceived modus operandi stating that you can only increase performances by augmenting hardware capacity is hereby challenged. An exemplary objective of the invention is to enhance the processing speed of a client request without the need for increasing the capacity of the hardware. In some embodiments, this is achieved by optimizing the transactions between the various methods and/or steps engaged into delivering the content of a client request from the server perspective.

In some embodiments, the invention makes the process more efficient because it moves the task of domain logic from the application to the DBMS. In one single query, the client request is received from the application to the DBMS. The DBMS then builds the content from the collected data for the application and communicates it in its entirety, to the latter, once completed. Therefor using a single cycle prepares the content and a single communication transfers it, thus freeing the application from the domain logic loop and allowing the application to focus more of its resources into content distribution to the client.

The invention may also make the application more stable since it reduces the amount of communication with the database. It has been noticed that the possibility of an error rises with the number of cycles. Having the domain logic in the application may also cause errors because the DBMS queries are often made reusable in order to make development more efficient. That reusable design may cause undesired results in the content being displayed to the client. It is generally accepted that the more communication and cycle you have, the more intermediaries methods are involved in the process, the greater the chances of an error occurring. By reducing the number of data transactions and cycles, the possibility of errors, while not being completely eliminated, is also reduced. The reduction of the communication needs of the application, likely stabilizes the application, thus reducing the likelihood of error.

The invention may also allow, because domain logic is moved to the DBMS, management of layouts of the produced content without updating files on a server, which often requires using a third party software. In some embodiments, the centralized layout management may further allow the application manager rely on a simple Internet connection to remotely edit the output of the DBMS methods.

Another possible positive effect of some embodiments of the present invention is to allow for more secure applications by limiting the numbers of publicly stored files and their significance on more exposed server. Because of the limited number of queries required, the number of access points available to a malevolent individual is also limited, making parameter sniffing more difficult, thereby rendering access to precious clues on how to obtain protected data more difficult. The invention allows for programming an application so that it inherently limits such errors as it is no longer a CMS. When the application is only expected to perform a single request, fraudulent attempts by the aggressor should not be recognized and should be ignored, severely incapacitating the ability of the aggressor to obtain clues as to the structure of the application.

Finally, it is expected that operational cost of an application can be significantly reduced. Whenever a communication takes place between an application and the DBMS, mobilization of physical resources is needed for the operation. For instance, if fifty operations are necessary, the mobilization is required fifty times. When the application does a single communication, the mobilization of physical resources is reduced. A significant reduction in the required resources related to the application occurs may be obtained by limiting the number of required communications between the application and the DBMS.

The exemplary improvements of performance may offer the application manager a considerable saving on operational cost related to the application as the servers and attached hardware elements may not have to work to their full strength could be dimensioned otherwise or could be affected to other tasks. Therefore, the invention allows for an application to operate with similar performances using less resources and therefore less hardware. By lowering the hardware needs, the electricity needs related to the application are also lowered. Hence, the application manager may also save on setup and operational costs related to the application. The invention also offers the possibility to develop a green alternative to typical application constructs in one of the most energy-consuming sector of the information technology industry.

In one embodiment, a DBMS-driven domain logic content delivery mechanism is provided. In the exemplary embodiments presented herein, the domain logic is defined as the part of a software that determines how data can be created, displayed stored and changed. For instance, the domain logic may represent the processes used to translate a content request from a client into readable, browser-ready produced content. The forth mentioned domain logic is located in the database instead of an application and uses a variety of methods to process raw data into browser-friendly and client-friendly produced content.

Embodiments of a database domain logic processing mechanism may be supported by a variety of computing devices and software setups. The described and exemplified computing devices and software are not meant to limit the scope of this invention, but are provided as a mean to better understand the steps involved in the delivery of a produced content.

Exemplary embodiments of the invention are performed by having the programming elements managing the content moved from the application to the DBMS. As such, rather than programming the domain logic inside the application, the domain logic may be located and executed by the DBMS. For example, in some embodiments, the methods managing the display elements, data manipulations, the client right management, interactivity and structure are fully executed within the DBMS. The DBMS executes the domain logic within the query; the resulting HTML is then transferred to the client through the application, which is not expected to perform other tasks than mediating between the DBMS and the client.

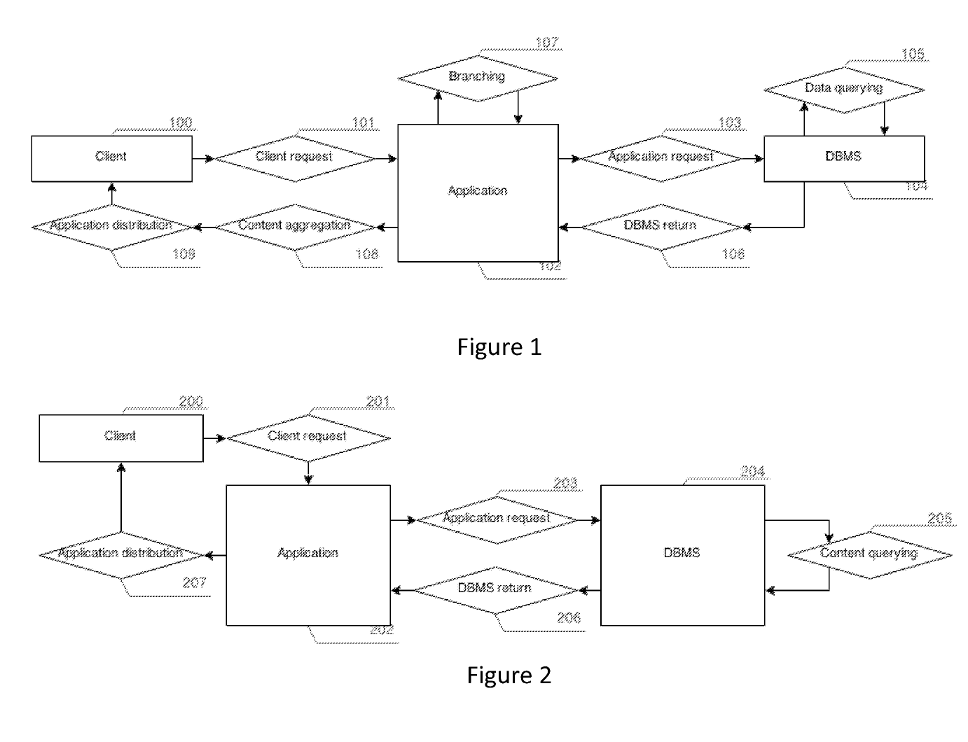

Reference is now made to the drawings in which FIG. 1 shows a logical modular representation and flow chart of steps involved in delivering the content of a client request from an application in accordance with an exemplary sub-optimal embodiment. In the depicted example, a client 100 sends a request for content 101 to an application 102 which in turns sends a request for data 103 to the DBMS 104, which in turns query the data 105. The DBMS 104 sends back the data 106 to the application 102. Branching 107 may occur when the content request requires multiple data requests, in which case the steps 103 to 106 will be repeated until all necessary data is acquired for the content aggregation 108. Once the content aggregation 108 is complete, the application then distributes 109 the produced content to the client 100.

The domain logic 107 and 108 and the data querying 105 are executed in at least two distinct processes. Moreover, server setups may typically locate the application 102 and the DBMS 104 on two different server instances, e.g. for stability, availability and security purposes. It is also usually required by the application 102 to process each data request sequentially, i.e., the application will not continue producing the content for the client 100 until it gets data returned 106 from the DBMS 104.

The data branching 107 is executed for each block of content required by the client 100 from the application 102. Each branching 107 will execute an instance of data request 103 sequentially then aggregate the data into produced content 108. Once this heap of branching 107 is completed, all of the aggregated content 108 is again aggregated 108 and distributed 109 to the client 100.

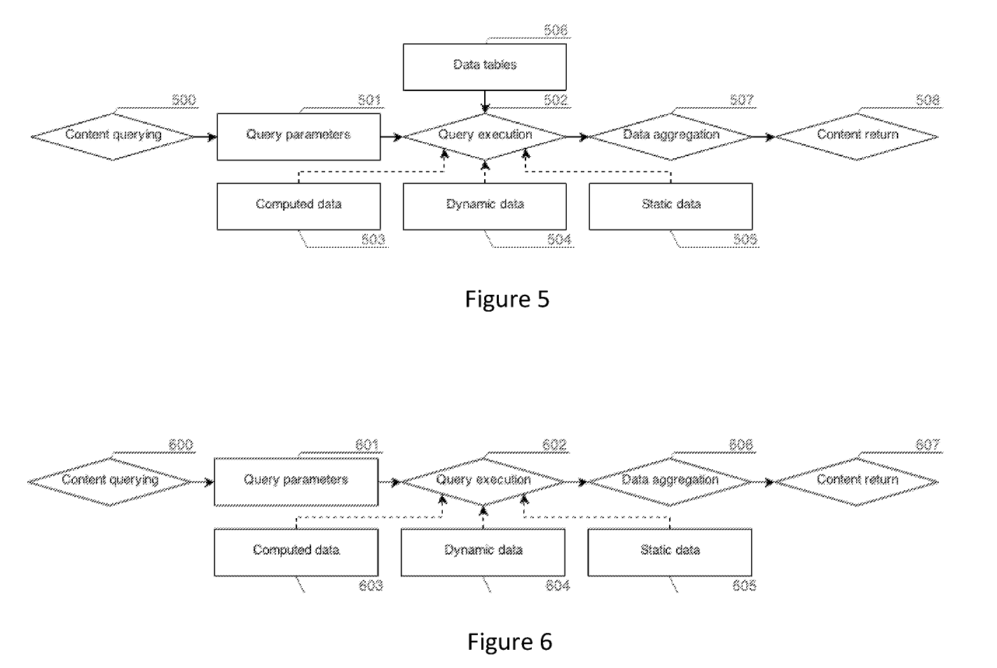

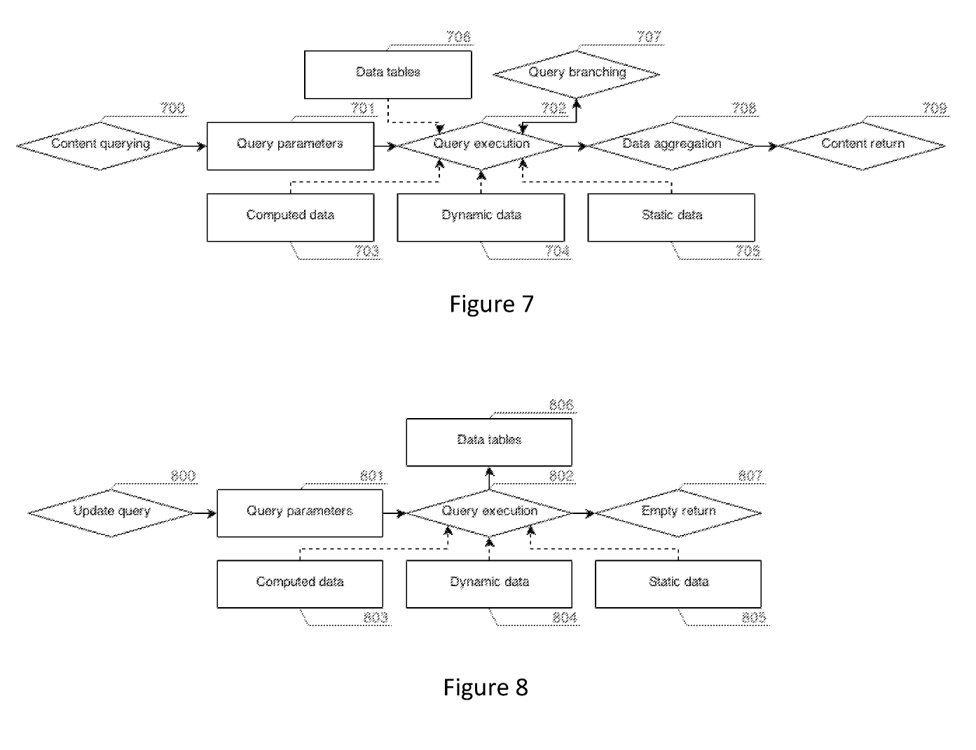

FIG. 2 shows a logical modular representation and flow chart of steps involved for a content request in accordance with one exemplary embodiment of the present invention. A client 200 sends a request for content 201 to an application 202. The application 202 then sends an application request 203 to a DBMS 204, which in turn executes a query for produced content 205, the DBMS 204 then returns the produced content 206 to the application 202, which in turn distributes the produced content 207 to the client 200. It should be noted that the query 205 may take many forms, which are further discussed with particular reference to FIG. 5, FIG. 6 and FIG. 7.

In the example of FIG. 2, the domain logic and the data querying, or content querying 205, are both located in the same server process (i.e., the DBMS 204) thus in the same server instance. In accordance with this example, the domain logic is executed while the produced content is being queried. An exemplary advantage of this embodiment is that it short-circuits the normal lifecycle of the application 202 and the DBMS 204 because the client's requested content is produced more efficiently in terms of delay, network usage, processing time and global energy consumption of the involved hardware devices in relation to the produced content.

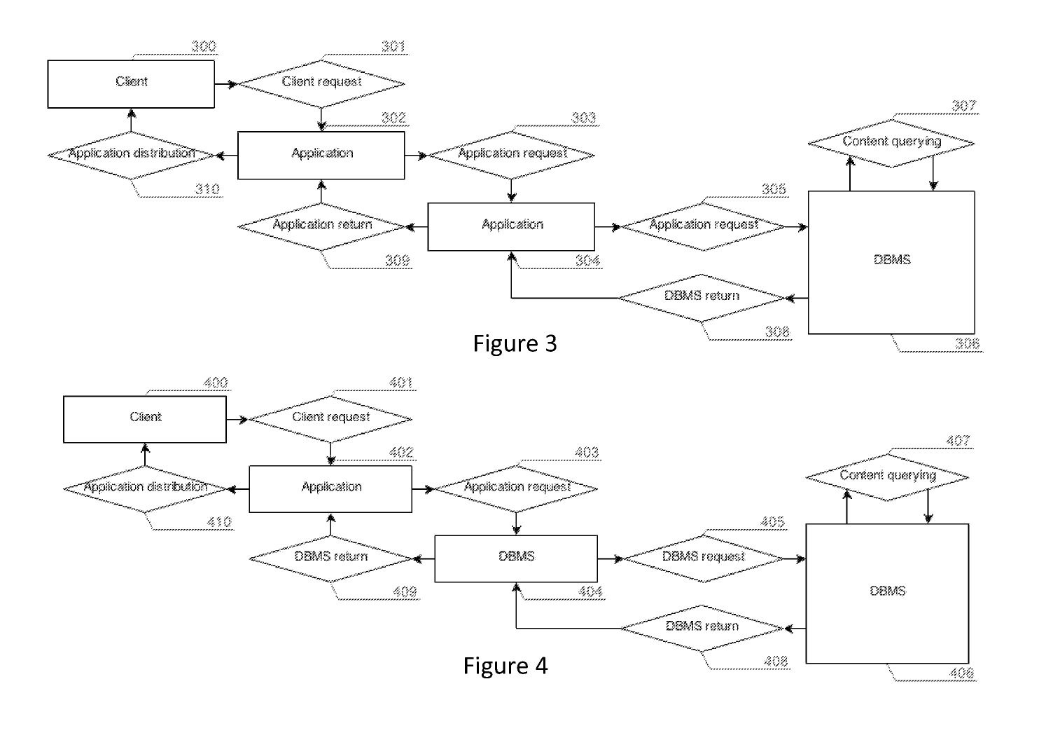

Referring together to FIG. 3 and FIG. 4, an application 302/402 that received a client request 301/401 from a client 300/400 is not limited to communicating with a DBMS 306/406. As depicted in the examples of FIG. 3 and FIG. 4, the application 302/402 can also communicate to a number of intermediaries processes 304/404 before distributing 310/410 produced content to the client 300/400. Exemplary additional processes involve may include, but are not limited to, a wide variety of applications, software, hardware or DBMS. More specifically, FIG. 3 depicts an example in which an application 304 receives an application request 303 from the application 302. The application 304 then sends an application request 305 to a DBMS 306, which queries 307 the produced content and returns it 308 to the application 304, which itself returns 309 the produced content to the application 302. FIG. 4 depicts an example in which a DBMS 404 receives an application request 403 from the application 402. The DBMS 404 then sends a DBMS request 404 to a DBMS 406, which queries 407 the produced content returns it 408 to the DBMS 404, which itself returns 409 the produced content to the application 402. For the sake of clarity, FIG. 3 and FIG. 4 only describe two of these exemplary possibilities.

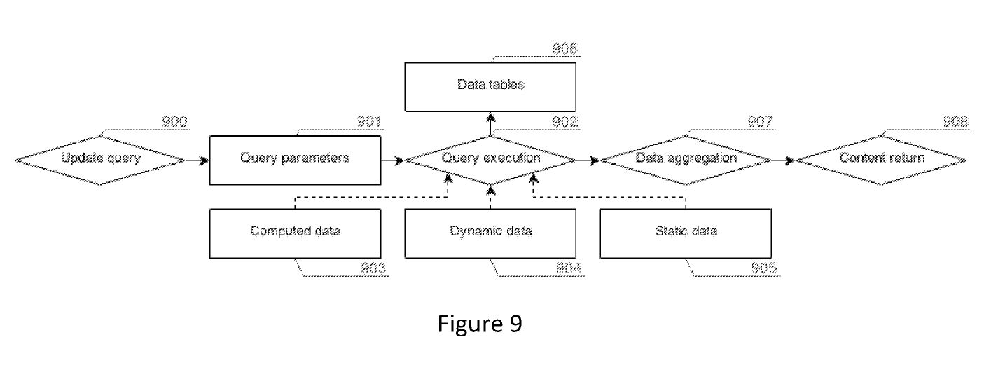

Reference is now concurrently made to FIG. 2, FIG. 5, FIG. 6, FIG. 7, FIG. 8 and FIG. 9, which provides exemplary embodiments of steps involved by the DBMS 204 in the content querying 205 to distribute 207 the produced content of the client 200 request 201 to the application 202. In the depicted example, elements denoted 500, 600, 700, 800 and 900 involve initialization of the content querying 205 whereas elements denoted 508, 607, 709, 807 and 908 involve the returning of the content querying 205. The following are only examples of the content querying 205 are provided to better illustrate the teachings of the present invention and not to limit the scope of the invention. Skilled persons will readily acknowledge that other content queries are possible within departing from the teachings of the present invention.

Referring to FIG. 2 and to FIG. 5, the content query 500 is meant to trigger execution of the query execution 502. The query execution 502 may optionally use different input parameters 501, e.g., to build statistics or to provide customised content. Examples of parameters 501 include browser identification, incoming web site address, IP address of the client, etc. Parameters may also be defined with default values, rendering such parameter optional at the time of execution. The query execution 502 is accessing one or more data tables 506 (considering eventual optional parameters 510). Executing the query 502 may also be performed by including computed data 503, dynamic data 504 and/or static data 505 with the data returned from the data tables 506. The result from the data sources is then aggregated 507 into produced content. The produced content is then returned 508 by the DBMS 204. For instance, the data tables 506 of a database may comprise data related to a given produced content corresponding to a web page with a first table T_MENU storing the menu of the web page and a second table T_BODY storing the body of the web page. The query 502 may comprise static data 505 such as header and footer information of the web page, dynamic data 504 such as preferred default language of the requesting client and computed data 503 such as a formula to calculate a maximum of different numerical values from the text of the web page. In this simple example, no query parameter 501 is provided. The query execution 502 returns data that is then aggregated 507 into the produced content. SQL examples are given herein below. Of course, skilled persons will readily understand how to correct and adapt the syntax of the exemplary SQL codes, which are not provided from instance execution on a server but to better illustrate the invention.

An exemplary request 502 in SQL that would match the example of FIG. 5 could be: SELECT “header text” as header_text, T_MENU.text, T_BODY.start text & CAST(MAX(T_Body.value1, T_BODY.value2) as String) & T_BODY.end text as body_text, “footer text” as footer_text FROM T_HEADER, T_MENU, T_BODY, T_FOOTER WHERE T_Menu.language=@SYS_client.language, T_MENU.id=@SYS_client.id and T_BODY.url=@SYS_client.url

As skilled persons will note, FIG. 6 presents an example similar to the example of FIG. 5, with the exception that there is no data tables being accessed. Referring to FIG. 2 and to FIG. 6, the content query 600 is meant to trigger execution of the query execution 602. Optional parameters 601 may be provided to the query execution 602, which comprises data is in the query itself, such as computed data 603, dynamic data 604 and/or static data 605. The result from the data sources is then aggregated 607 into produced content. The produced content is then returned 608 by the DBMS 204.

An exemplary request 602 in SQL that would match the example of FIG. 6 could be: SELECT “header text” as header_text, “start body text” & CAST(MAX(T_Body.value1, T_BODY.value2) as String) & “end body text” as Body_text, “footer text” as Footer_text FROM T_HEADER, T_MENU, T_BODY, T_FOOTER WHERE T_Menu.language=@SYS_client.language, T_MENU.id=@SYS_client.id and T_BODY.url=@SYS_client.url

As skilled persons will note, FIG. 7 presents an example similar to the example of FIG. 5, with the exceptions that the data table access is optional in FIG. 7. An exemplary feature that differs between FIG. 7 and FIG. 5 is that FIG. 7 depicts query branching 707.

Referring to FIG. 2 and FIG. 7, the content query 700 is meant to trigger execution of the query execution 702. With its optional parameters 701, the query execution 702 is accessing one or more of computed data 703, dynamic data 704, static data 705, data tables 706 and query branching 707. The query branching 707 involves execution of one or more child queries by a parent query. There is no limitation to the number of child queries or level of parenthood by queries. Each individual child query from the query branching 707 can execute a variety of processes that may or may not return aggregated content or may or may not return data to its parent query. Then, the root query located at the query execution 702 may or may not, partially or entirely aggregate the data and/or content of the child queries from the query branching 707. The data is then aggregated 708 into produced content, which in turn is returned 709 by the DBMS 204.

An exemplary request 702 in SQL that would match the example of FIG. 7 could be: SELECT body_content as body_content FROM T_fn_Branched_Query(@SYS_client.language,@SYS_client.id,@SYS_client.url)

Referring to FIG. 8 and to FIG. 2, an update query 800 replaces the content query 205. The update query 800 is meant to trigger execution of the query execution 802 with its optional parameters 801. The executing query 802 may or may not access computed data 803, dynamic data 804 and/or static data 805. The query execution 802 will use one or more of the previously mentioned data sources, the optional parameters 801, computed data 803, dynamic data 804 and/or static data 805 to update one or more data tables. Once the query execution is done, it returns no data and/or content by the DBMS 204.

An exemplary request 802 in SQL that would match the example of FIG. 8 could be: UPDATE blog_content SET blog_title=@SYS Title, blog_content=@SYS_Content WHERE T_Menu.language=@SYS_client.language, T_MENU.id=@SYS_client.id and T_BODY.url=@SYS_client.url

As skilled person will note, FIG. 9 presents an example similar to the example of FIG. 8, with the exception that the empty return 807 is replaced by a content aggregation 907 and a content return 908. Referring to FIG. 2 and FIG. 9, an update query 900 replaces the content query 205. The update query 900 is meant to trigger the execution of the query execution 902. With its optional parameters 901, the query execution 902 is accessing one or more of computed data 903, dynamic data 904 and/or static data 905. The query execution 902 will use one or more of the previously mentioned data sources, the optional parameters 901, computed data 903, dynamic data 904 and/or static data 905 to update one or more data tables. The query execution 902 then proceeds to aggregate the data 907 into produced content. The produced content is then returned 908 by the DBMS 204.

An exemplary request 902 in SQL that would match the example of FIG. 9 could be: MERGE Products AS Target USING UpdatedProducts AS Source ON Target.ID=Source.ID WHEN MATCHED and Target.Name < > Source.Name OR Target.Rate < > Source.Rate THEN UPDATE SET Target.Name=Source.Name, Target.Rate=Source.Rate WHEN NOT MATCHED BY TARGET THEN INSERT (Id,Name,Rate)VALUES(Source.ID,Source.Name,Source.Rate)WHEN NOT MATCHED BY SOURCE THEN DELETE OUTPUT $action AS PerformedAction,DELETED.Id OldProductID,DELETED.Name OldPRoductName,INSERTED. Id NewProductld,INSERTED.Name NewProductName

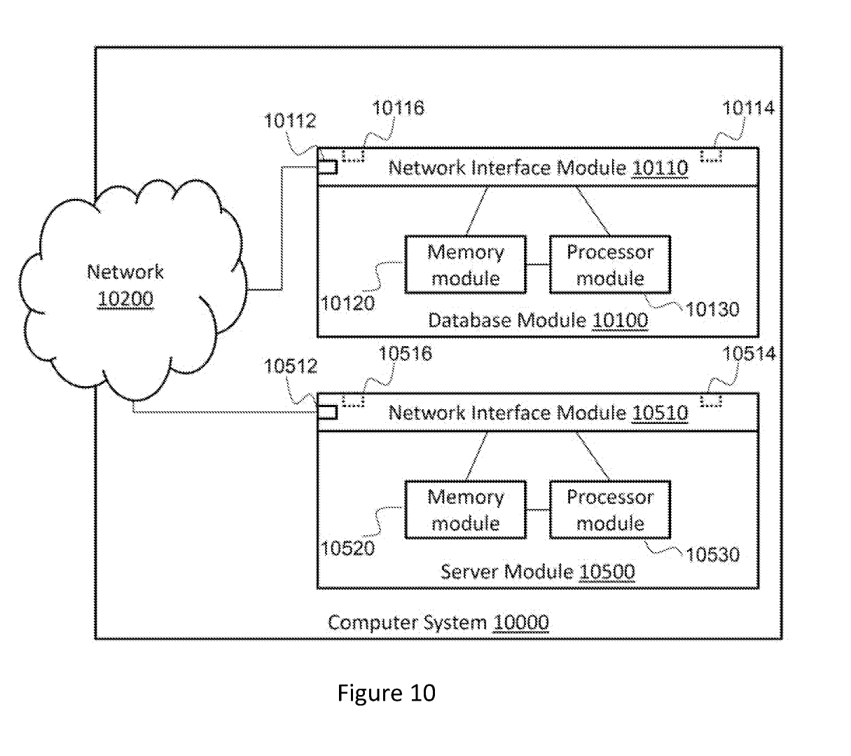

FIG. 10 shows a modular representation of an exemplary embodiment of a computer system 10000 in accordance with the teachings of the present invention. The computer system 10000 depicted in the example of FIG. 10 comprises a database module 10100 and a server module 10500. A network 10200 is shown interconnecting the database module 10100 and the server module 10500. In some embodiments, the database module 10100 and the server module 10500 may be in direct communication without involving the network 10200. The network 10200 may be a logical internal network to the computer system 10000 and/or provide external network connectivity to the modules of the computer system 10000. The modules of the computer system 10000 may connect with external nodes (not shown) directly without involving the network 10200. Skilled persons will readily understand that all links required for such network connectivity are not depicted. Links may also represent logical connections and different network nodes (e.g., routers, switches, etc.) may be present thereon.

The database module 10100 and the server module 10500 may be physical modules of the computer system 10000 implemented on one or more hardware platforms (e.g., server blades). The database module 10100 and the server module 10500 may also be logical modules (e.g., virtual machines or cloud instantiation of a module) of the computer system 10000 implemented on one or more hardware platforms (e.g., server blades).

The database module 10100 as depicted comprises a network interface module 10110, a memory module 10120 and a processor module 10130. The network interface module 10110 comprises at least one physical interface 10112 connected to the network 10200. The network interface module may also comprise other interfaces 10114 . . . 10116 (e.g., a logical network card, a Local Area Network (LAN) interface, a Wide Area Network (WAN) interface and/or a Wireless LAN, etc.). The WAN interface, if present, could be based on Ethernet or other wireline protocol(s) or could be a wireless interface (e.g., 3G, WiMax, 4G/LTE cellular network, etc.).

The server module 10500 as depicted comprises a network interface module 10510, a memory module 10520 and a processor module 10530. The network interface module 10510 comprises at least one physical interface 10512 connected to the network 10200. The network interface module may also comprise other interfaces 10514 . . . 10516 (e.g., a logical network card, a Local Area Network (LAN) interface, a Wide Area Network (WAN) interface and/or a Wireless LAN, etc.). The WAN interface, if present, could be based on Ethernet or other wireline protocol(s) or could be a wireless interface (e.g., 3G, WiMax, 4G/LTE cellular network, etc.).

The network interface module 10510 of computer system 10000 may receive a request for content for an application executing on a remote network node. In response to the request, the computer system 10000 causes the computer system to perform one or more queries (e.g., the server module 10500 receives information, e.g., through network interface module 10510 to send a query to the database module 10100). The network interface module 10510 of computer system 11000 may then send a dataset corresponding to the one or more queries. The dataset comprises produced content ready to be distributed to the application as a single response related to the request. The database module 10100 may perform the one or more queries towards one or more database tables. The one or more queries may also contain data without reference to one or more database tables. Each of the one or more queries may also comprise at least some of the raw data from the request.

The database module 10100 may have an internal database address 10114 on the network interface module 10110 and the server module 10500 may have an external server address 10512 on the network interface module and an internal server address 10514 on the network interface module 10510. The server module may further receive a client request for content from the application executing on the remote network node on the external server address 10512 of the network interface module 10510, sending the request for the application comprising data from the client request on the internal database address 10114 of the network interface module 10110 and, following reception of the produced content on the internal server address 10514 of the network interface module 10510 from the database module 10100, send the single response to the client request comprising the produced content towards the application.

The application may be a consumer and the produced content may be ready to be processed as is by the consumer. The produced content may comprise HTML code, XML code, binary code and/or JSon code. The produced content may comprise dynamic data comprising at least one of parsed raw data from the client request, dynamic data from the dataset and computed dynamic data.

At least one of the one or more queries may comprise a function that requires at least one parameter and contains at least one query. The function may produce the produced content and the one or more queries may then return the produced content as is.

At least one of the one or more queries may be sent to a server-side procedure and the server-side procedure may convert the raw data from the client request into parameters.

At least one of the one or more queries may be sent to a server-side procedure and the server-side procedure may proceed to branching including a plurality of SQL objects. The plurality of SQL objects may comprise at least one of simple SQL queries, TVF, UDF, SP, arithmetic operations, simple string aggregation and execution of compiled programming. The plurality of SQL objects use dynamic data and/or computed data and/or static data for creating the produced content.

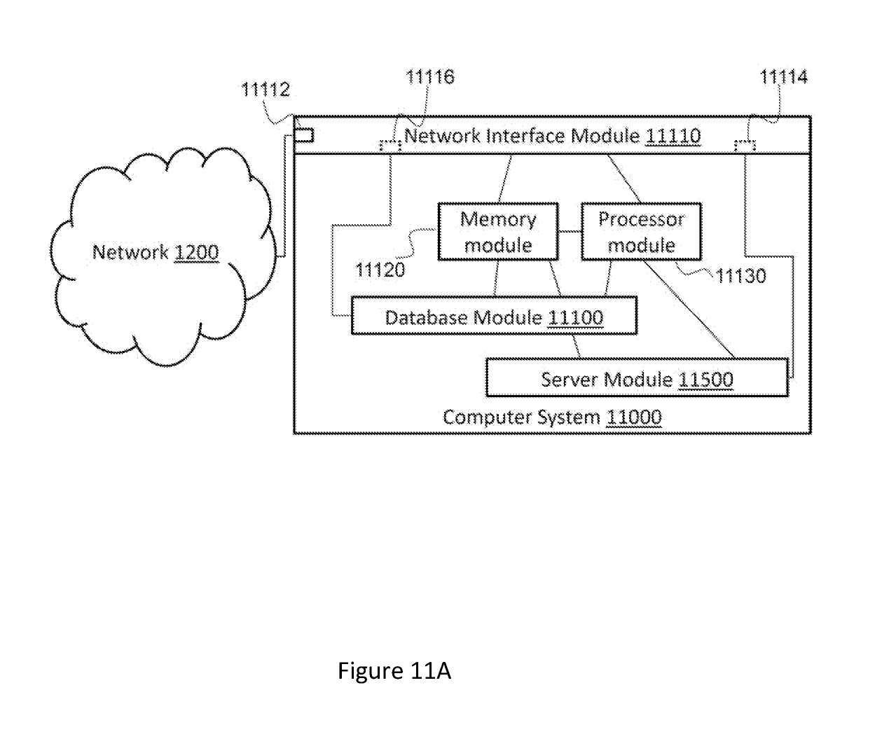

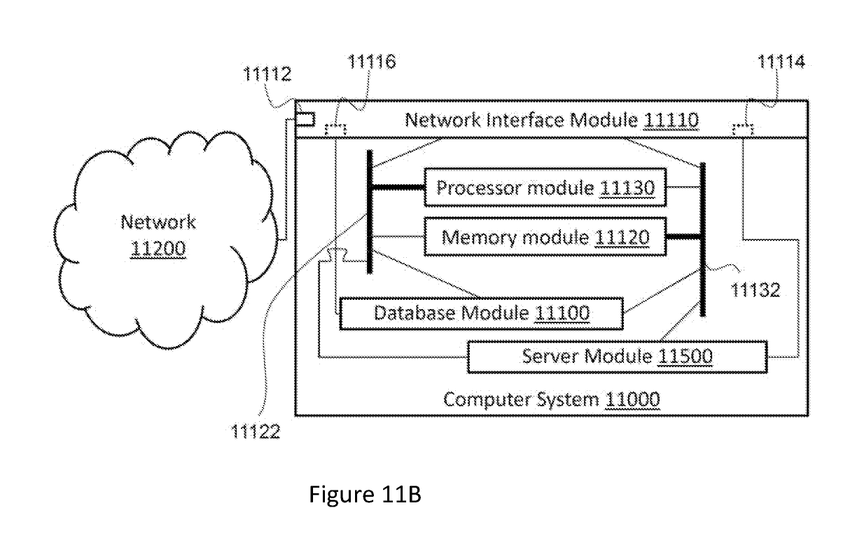

FIG. 11 shows a modular representation of an exemplary embodiment of a computer system 11000 in accordance with the teachings of the present invention. The computer system 11000 depicted in the example of FIG. 11 comprises a database module 11100 and a server module 11500. The computer system is depicted connected to a network 11200. The modules of the computer system 11000 may connect with external nodes (not shown) directly without involving the network 11200. Skilled persons will readily understand that all links required for such network connectivity are not depicted. Links may also represent logical connections and different network nodes (e.g., routers, switches, etc.) may be present thereon.

The database module 11100 and the server module 11500 may be physical modules of the computer system 11000 implemented on one or more hardware platforms (e.g., server blades). The database module 11100 and the server module 11500 may also be logical modules (e.g., virtual machines or cloud instantiation of a module) of the computer system 11000 implemented on one ore more hardware platforms (e.g., server blades).

The computer system 11000 as depicted comprises a network interface module 11110, a memory module 11120 and a processor module 11130. The network interface module 11110 comprises at least one physical interface 11112 connected to the network 11200. The network interface module may also comprise other interfaces 11114 . . . 11116 (e.g., a logical network card, a Local Area Network (LAN) interface, a Wide Area Network (WAN) interface and/or a Wireless LAN, etc.). The WAN interface, if present, could be based on Ethernet or other wireline protocol(s) or could be a wireless interface (e.g., 3G, WiMax, 4G/LTE cellular network, etc.).

The processor modules 10130/10530/11130 may represent a single processor with one or more processor cores or an array of processors, each comprising one or more processor cores. The memory module 10120/10520/11120 may comprise various types of memory (different standardized or kinds of Random Access Memory (RAM) modules, memory cards, Read-Only Memory (ROM) modules, programmable ROM, etc.). The network interface module 10110/10510/11110 represents at least one physical interface that can be used to communicate with other network nodes. The network interface module 10110/10510/11110 may be made visible to the other modules of the computer system 10000/11000 through one or more logical interfaces. The actual stacks of protocols used by the physical network interface(s) and/or logical network interface(s) of the network interface module 10110/10510/11110 do not affect the teachings of the present invention. The variants of processor module, memory module, network interface module usable in the context of the present invention will be readily apparent to persons skilled in the art. Likewise, even though explicit mentions of the memory module and/or the processor module are not made throughout the description of the present examples, persons skilled in the art will readily recognize that such modules are used in conjunction with other modules of the computer system 10000/11000 to perform routine as well as innovative steps related to the present invention.

The network interface module 11110 of computer system 11000 may receive a request for content for an application executing on a remote network node. In response to the request, the computer system 11000 causes the computer system to perform one or more queries (e.g., the processor module 11130 receives information, e.g., through network interface module 11110 to send a query to the database module 11100). The network interface module 11110 of computer system 11000 may then send a dataset corresponding to the one or more queries. The dataset comprises produced content ready to be distributed to the application as a single response related to the request. The database module 11100 may perform the one or more queries towards one or more database tables. The one or more queries may also contain data without reference to one or more database tables. Each of the one or more queries may also comprise at least some of the raw data from the request.

The database module 11100 may have an internal database address 11116 on the network interface module 11110 and the server module 11500 may have an external server address 11112 on the network interface module and an internal server address 11114 on the network interface module 11110. The server module 11500 may further receive a client request for content from the application executing on the remote network node on the external server address 11112 of the network interface module 11110, sending the request for the application comprising data from the client request on the internal database address 11116 of the network interface module 11110 and, following reception of the produced content on the internal server address 11114 of the network interface module 11110 from the database module 11100, send the single response to the client request comprising the produced content towards the application.

The application may be a consumer and the produced content may be ready to be processed as is by the consumer. The produced content may comprise HTML code, XML code, binary code and/or JSon code. The produced content may comprise dynamic data comprising at least one of parsed raw data from the client request, dynamic data from the dataset and computed dynamic data.

At least one of the one or more queries may comprise a function that may require at least one parameter and contains at least one query. The function may produce the produced content and the one or more queries may then return the produced content as is.

At least one of the one or more queries may be sent to a server-side procedure and the server-side procedure may convert the raw data from the client request into parameters.

At least one of the one or more queries may be sent to a server-side procedure and the server-side procedure may proceed to branching including a plurality of SQL objects. The plurality of SQL objects may comprise at least one of simple SQL queries, TVF, UDF, SP, arithmetic operations, simple string aggregation and execution of compiled programming. The plurality of SQL objects use dynamic data and/or computed data and/or static data for creating the produced content.

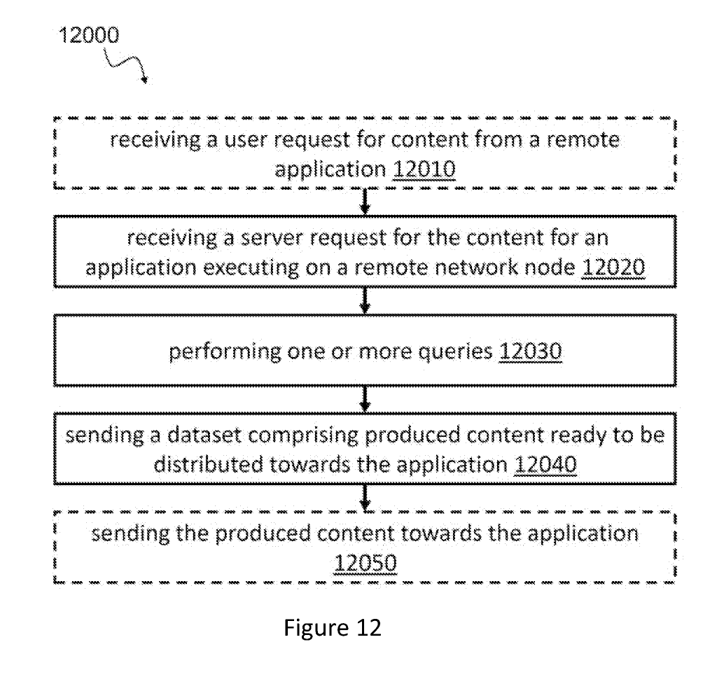

FIG. 12 shows a flow chart of an exemplary method 12000 for obtaining produced content comprising. The method comprises, at a computer system, receiving 12020 a request for content via a network interface module of the computer system. The request is related to an application executing on a remote network node. In response to the request, the method 12000 comprises performing one or more queries 12030. The method 12000 also comprises, from the computer system, sending 12040 a dataset corresponding to the one or more queries. The dataset comprises produced content ready to be distributed to the application as a single response related to the request via the network interface module of the computer system.

The one or more queries may be made towards one or more database tables, the one or more queries may contain data without reference to one or more database tables and/or each query comprises at least some of the raw data from the client request.

The computer system may comprise a server module having an external server address on the network interface module and an internal server address on the network interface module and a database module for performing the one or more queries having an internal database address on the network interface module. The method may then further comprise receiving 12010, on the external server address of the network interface module, a client request for content from the application executing on the remote network node, sending the request comprising data from the client request towards the internal database address of the network interface module and, following reception of the produced content on the internal server address of the network interface module from the database module, sending 12050 the single response to the client request comprising the produced content towards the application from the external server address of the network interface module.

In the context of the present invention, the consumer may be an end-client Web browser and the produced content may be a Web page ready to be processed by the end-client Web browser. The consumer may also be an application interacting with one or more layer of consumer application. The child application may be a content producer to the parent application.

The produced content may comprise HTML code, XML code, JSon code and/or binary code. The produced content may comprise dynamic data comprising at least one of parsed raw data from the client request, dynamic data from the dataset and/or computed dynamic data.

At least one of the one or more queries may comprise a function (e.g., TVF, SVF) comprising at least some domain logic. The function may require at least one parameter and contains at least one query. The function further produce the produced content and the one or more queries return the produced content as is.

At least one of the one or more queries may comprise a procedure. The procedure may convert the raw data from the consumer request into parameters. The procedure may also proceed to branching into/including a plurality of SQL objects. The plurality of SQL objects may comprise one or more SQL query, TVF, UDF, SP, SVF, compiled code, arithmetic operations and/or string aggregation. The plurality of SQL objects may also use dynamic and/or computed data and/or static data for creating the produced content.

The computed data is obtained by a constructor query from one or more database table when the data is modified and/or added and/or deleted. The data is then built into the produced query by the constructor query in order to avoid accessing the one or more database table for each consumer request of a normal query. The static data is built directly into the query and is not loaded from a dynamic data at the execution of the query or computed by a constructor query.

The computer system may further provide a server and/or database management system.

Various network links may be implicitly or explicitly used in the context of the present invention. While a link may be depicted as a wireless link, it could also be embodied as a wired link using a coaxial cable, an optical fiber, a category 5 cable, and the like. A wired or wireless access point (not shown) may be present on the link between. Likewise, any number of routers (not shown) may be present and part of the link, which may further pass through the Internet.

The present invention is not affected by the way in which the different modules exchange information between them. For instance, different memory modules and processor modules (not shown) could be connected by a parallel bus, but could also be connected by a serial connection or involve one or more intermediate modules (not shown) without affecting the teachings of the present invention.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities. The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

1. A computer system comprising:
a network interface module for:
receiving a request for content for an application executing on a remote network node;
in response to the request, causing the computer system to perform one or more queries; and
sending a dataset corresponding to the one or more queries, the dataset comprising produced content ready to be distributed to the application as a single response related to the request.

2. The computer system of claim 1 further comprising a database module for performing the one or more queries towards one or more database tables.

3. The computer system of claim 1 further comprising a database module for performing the one or more queries, wherein the one or more queries contain data without reference to one or more database tables.

4. The computer system of claim 1 further comprising a database module for performing the one or more queries, wherein each of the one or more queries comprises at least some of the raw data from the request.

5. The computer system of claim 1 further comprising:
a database module for performing the one or more queries having an internal database address on the network interface module; and
a server module having an external server address on the network interface module and an internal server address on the network interface module;
wherein the server module is further for:
receiving a client request for content from the application executing on the remote network node on the external server address of the network interface module;
sending the request for the application comprising data from the client request on the internal database address of the network interface module; and
following reception of the produced content on the internal server address of the network interface module from the database module, sending the single response to the client request comprising the produced content towards the application.

6. The computer system of claim 5, wherein the application is a consumer and wherein the produced content is ready to be processed as is by the consumer.

7. The computer system of claim 6, wherein the produced content comprises HTML code, XML code, binary code and/or JSon code.

8. The computer system of claim 6, wherein the produced content comprises dynamic data comprising at least one of parsed raw data from the client request, dynamic data from the dataset and computed dynamic data.

9. The computer system of claim 1 further comprising a database module for performing the one or more queries, wherein at least one of the one or more queries comprises a function, wherein the function requires at least one parameter and contains at least one query.

10. The computer system of claim 9, wherein the function produces the produced content and the one or more queries return the produced content as is.

11. The computer system of claim 1 further comprising a database module for performing the one or more queries, wherein at least one of the one or more queries are sent to a server-side procedure, wherein the server-side procedure converts the raw data from the client request into parameters.

12. The computer system of claim 1 further comprising a database module for performing the one or more queries, wherein at least one of the one or more queries are sent to a server-side procedure, wherein the server-side procedure proceeds to branching including a plurality of SQL objects.

13. The computer system of claim 12, wherein the plurality of SQL objects comprises at least one of simple SQL queries, TVF, UDF, SP, arithmetic operations, simple string aggregation and execution of compiled programming.

14. The computer system of claim 13, wherein the plurality of SQL objects use dynamic data and/or computed data and/or static data for creating the produced content.

15. A method for obtaining produced content comprising:
at a computer system, receiving a request for content via a network interface module of the computer system, wherein the request is related to an application executing on a remote network node;
in response to the request, performing one or more queries; and
from the computer system, sending a dataset corresponding to the one or more queries, the dataset comprising produced content ready to be distributed to the application as a single response related to the request via the network interface module of the computer system.

16. The method of claim 15, wherein:
the one or more queries are made towards one or more database tables;
the one or more queries contain data without reference to one or more database tables; and/or
each query comprises at least some of the raw data from the client request.

17. The method of claim 15, wherein the computer system comprises a server module having an external server address on the network interface module and an internal server address on the network interface module and a database module for performing the one or more queries having an internal database address on the network interface module, the method further comprising:
receiving, on the external server address of the network interface module, a client request for content from the application executing on the remote network node;
sending the request comprising data from the client request towards the internal database address of the network interface module; and
following reception of the produced content on the internal server address of the network interface module from the database module, sending the single response to the client request comprising the produced content towards the application from the external server address of the network interface module.

18. The method of claim 17, wherein the application is a consumer and wherein the produced content is ready to be processed by the consumer.

19. The method of claim 18, wherein the produced content comprises:
HTML code, XML code, binary code and/or Bon code; and/or
dynamic data comprising at least one of parsed raw data from the client request and dynamic data from the dataset and computed dynamic data.

20. The method of claim 15, wherein at least one of the one or more queries comprises a function, wherein the function requires at least one parameter and contains at least one query, the function producing the produced content and the one or more queries return the produced content as is.

21. The method of claim 15, wherein at least one of the one or more queries are sent to a server-side procedure, wherein the server-side procedure converts the raw data from the client request into parameters or wherein the server-side procedure proceeds to branching including a plurality of SQL objects.

22. The method of claim 21, wherein the plurality of SQL objects comprises at least one of simple SQL queries, TVF, UDF, SP, arithmetic operations, simple string aggregation and execution of compiled programming and wherein the plurality of SQL objects use dynamic data and/or computed data and/or static data for creating the produced content.

23. A computer system comprising:
a network interface module for:
receiving a client request for content from an application executing on a remote network node;
in response to the client request, sending a server request for the content to a database management system;
receiving a dataset corresponding to the requested content from the database management system, the dataset comprising produced content ready to be distributed; and
sending the produced content towards the application in a single response to the client request.

24. The computer system of claim 23, wherein sending the server request for the content to the database management system comprises sending a single server request that comprises raw data from the client request.

25. The computer system of claim 23, wherein the dataset is obtained at the database management system from one or more queries.

26. The computer system of claim 25, wherein:
the one or more queries are made towards one or more database tables;
the one or more queries contain data without reference to one or more database tables; and/or
each query comprises at least some of the raw data from the client request.
